(19) United States
(12) Patent Application Publication
(10) Pub. No.: US 2015/0053091 A1
(43) Pub. Date: Feb. 26, 2015

(54) METAL CONTAINER WITH RFID TAG FOR CONTAINING GAS

(71) Applicant: Strauss Water Ltd., Petach Tikva (IL)

(72) Inventor: Haim Wilder, Raanana (IL)

(73) Assignee: Strauss Water Ltd., Petach Tikva, IL (US)

(21) Appl. No.: 14/364,275

(22) PCT Filed: Dec. 4, 2012
(86) PCT No.: PCT/IL2012/050499

§ 371 Date: Jun. 10, 2014

Related U.S. Application Data
(60) Provisional application No. 61/570,673, filed on Dec. 14, 2011.

(30) Foreign Application Priority Data
Dec. 13, 2011 (IL) 216929

(51) Int. Cl. F17C 13/00; G06K 19/077; B01F 3/04; G09F 3/02; A23L 2/54

(52) U.S. Cl. CPC F17C 13/003; G09F 3/02; A23L 2/54; B01F 3/04099; G06K 19/07771; G09F 2003/0272
USPC 99/323.2; 206/459.5; 220/581; 235/492

(57) ABSTRACT

This invention relates to a container containing a fluid, such as pressurized gas, and a machine with a receptacle for utilizing such container.

### REFERENCE TO RELATED APPLICATIONS

This application is a national stage application under 35 USC 371 of International Application No. PCT/IL2012/050499, filed Dec. 4, 2012, which claims the priority of Israeli Patent Application No. 216929, filed Dec. 13, 2011 and Provisional Application No. 61/570,673, filed Dec. 14, 2011, the entire contents of which are incorporated herein by reference.

### FIELD OF THE INVENTION

This invention relates to a container containing a fluid, such as pressurized gas, and a machine with a receptacle for utilizing such container. A particular, but not limiting, example of such container is one containing pressurized carbon dioxide (CO₂) and a machine for preparing a carbonated drink utilizing it.

### BACKGROUND OF THE INVENTION

RFID (radio-frequency identification) elements are commonly used for labeling and identification of goods. Such RFID elements are used to store data relating to said goods, such as manufacturing data, shipping information, authenticity identification, etc. The RFID element is usually passive, namely, such that is unable to actively transmit data, and therefore requires the use of an appropriate external de-coder (or reader) enabling reading of the information stored on the RFID element. However, other arrangements are known, in which the RFID element also comprises an antenna and an energy source, such as a battery, enabling active transmission of data from the RFID to the reading device (such as those described in WO 2005/111961).

In most cases, the RFID element is in the form of a label, or a tag, which can be removably adhered to an external surface of an object (as described, for example, in U.S. Pat. No. 7,868,765). These labels, however, are prone to forgery, as they are easily accessible and replaced.

Other arrangements provide an RFID element embedded in a single point within the object side-wall (as described, for example, in US 2008/0012687 and WO 2011/046631). Such labeling or embedding does not facilitate usage of simple automatic reading equipment, as proper reading of the data on the label requires accurate positioning of the RFID element with respect to the reading device. This problem is of enhanced significance when the object bearing the label is a replaceable element within an elaborate system, based on user-operation. In such cases, a solution providing fail-proof identification is required, namely, that the positioning of the RFID element and reader will not require intervention or adjustment by the user.

### SUMMARY OF THE INVENTION

The current disclosure provides a metal container containing a fluid, configured for replaceable incorporation into a machine in which the fluid is utilized. A particular, non-limiting example is a metal container containing pressurized CO₂, which is incorporated into a machine for preparation of a carbonated drink, typically in a unit quantity. The container is of the kind intended for replacement, once the fluid in it has been exhausted.

The container of the present disclosure comprises an identification module, which is fitted at the base of the container. This identification module comprises an RFID element that stores data relating to identifiers of the container that can be transmitted, via the RF transceiver circuitry of said element to communicate such data to an appropriate RF communication module properly positioned within the machine. In this manner, the machine processor, included within the machine, can receive container-related identifiers, such as, but not limited to, container authenticity data, identifiers of the fluid-filling facility and of the extent of utilization of fluid within the container.

Thus, the present disclosure provides a metal container containing a fluid for replaceable incorporation into a machine in which the fluid is utilized. The container has a base with an identification module incorporated in it. The identification module comprises an RFID element for storing data relating to the container's identifiers and for communicating such data to an RF communication module in the machine.

The present disclosure also provides a machine comprising a receptacle for a fluid-containing container of the above kind having a base and an opening. The machine comprises a fitting arrangement for fitting with the opening and for drawing fluid therefrom. The receptacle comprises an RF communication module for communication with the RFID element at the container's base to obtain data on the container's identifiers.

According to one embodiment, the identification module is positioned within a recess formed at the base of the container, typically at its center. Such an arrangement allows for repeatedly matched and accurate positioning of the identification module and the RF read/write module upon replacement of the container by the user.

By one embodiment, the identification module comprises a shielding element between the RFID element and the juxtaposed portion of the base. As the container is made of metal, such a shielding element prevent refractions of the RF signal and allows for directional reading/transmitting of RF signals to/from the RFID element. The shielding element is typically in the form of a plate but may have other forms, e.g. dome-like, being curved, etc., and is positioned between the RFID element and the juxtaposed portion of the base. The shielding element may typically be made of a ferromagnetic metal/alloy, such as ferrite steel, zinc-ferrite, manganese-zinc-ferrite, barium-ferrite, cobalt-ferrite, etc.

By an embodiment of the current disclosure provided is an identification module, comprising an RFID element and a shield plate for fitting into a recess formed in a metal container. The fitting is such that the shield plate is situated between the RFID element and the wall portion in said recess. Typically the identification module is formed so its external face (namely that face which overlays the RFID element) is made to be flush with the external face of the container when fitted into the recess. The fixing of the identification module into the recess may be by adhering, using an adhesive or by any other suitable means.

The RFID element stores data relating to the container. The data may include an identifier of the authenticity of the container, which may serve, for example, as a measure of quality control. Furthermore, the identifier may be that of the fluid-filling facility in which the container has been filled with the fluid, and may serve a similar purpose. The processor operating within the machine may thus be configured to block operation of the machine where authenticity-indicating data is not read by the RF read/write module; or where the identifier is not that of an authorized fluid-filling facility.

The data stored in the RFID element may also include usage data. For example, the amount of fluid utilized by the machine may be inputted to the element through the RF communication module, and may be used as a counter to gauge the amount of fluid remaining within the container. The utilization of fluid may be gauged either by the number of quantified withdrawals of fluid from the container, or directly based on flow/volume measurement of the fluid withdrawn from the container. Where a used container is accidentally or deliberately introduced into the same or different machine, such usage data may provide an indication on the amount of residual fluid remaining within the container.

In accordance with one embodiment of the current disclosure, the fluid is a pressurized gas, such as CO₂, as already noted above; and in accordance with this embodiment, such a container is typically utilized within a machine for the preparation of a carbonated drink. Such a machine may be for use at home, office, etc.

The metal container is typically constructed of an aluminum-based alloy or steel-based but, as will be appreciated, the invention is not limited to such a container.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a side view of a container, according to an embodiment of the current disclosure.

FIG. 2 shows a bottom perspective view of a container of FIG. 1.

FIG. 3 shows a longitudinal cross-section through the container across the A-A line.

FIG. 4 is an enlarged view of the section marked B in FIG. 3.

FIG. 5 is a schematic representation of a machine according to the disclosure herein.

### DETAILED DESCRIPTION OF EMBODIMENTS

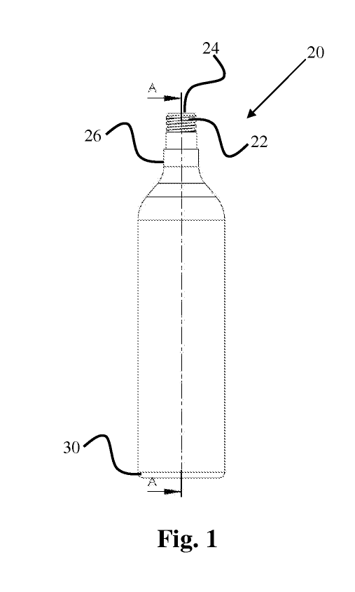

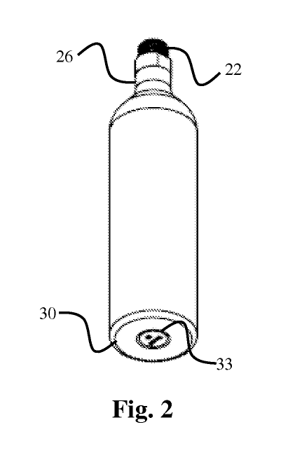

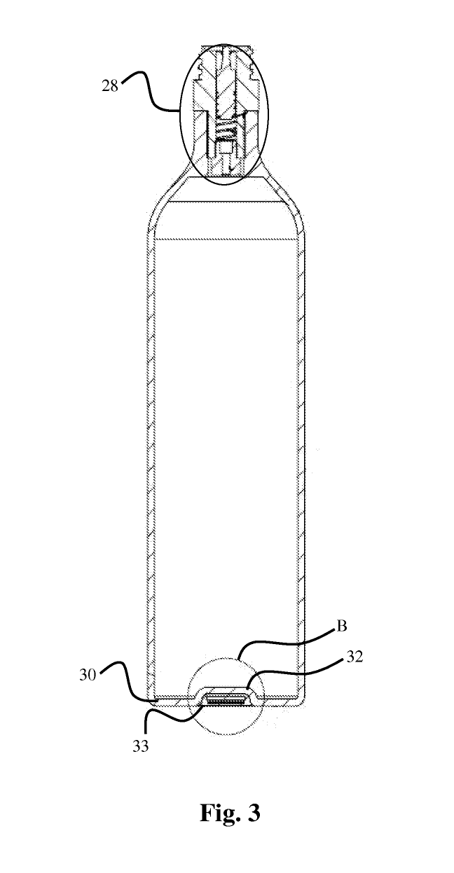

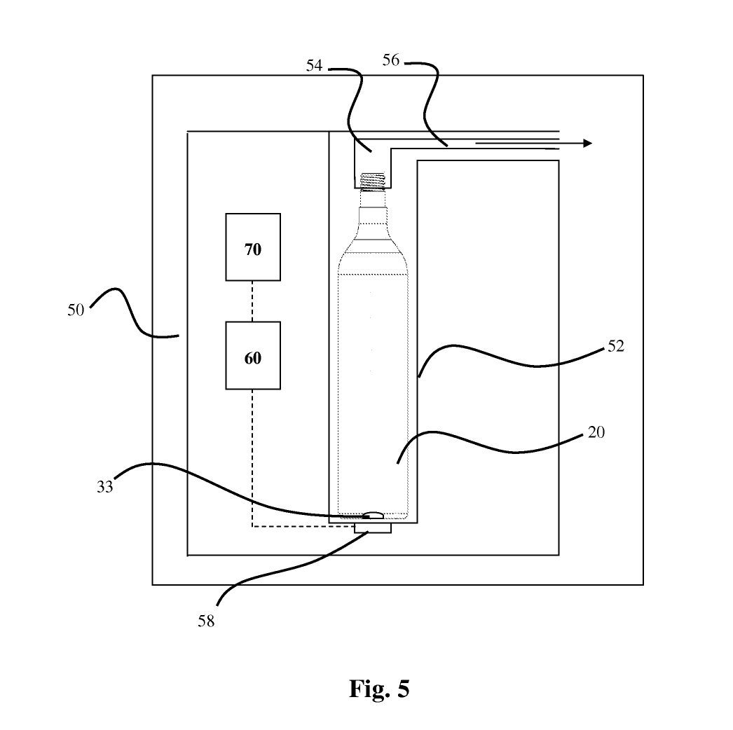

Reference is now made to FIGS. 1-4, showing a metal container 20 that can contain a fluid, such as pressurized CO₂, adapted for replaceable incorporation into a machine (schematically shown in FIG. 5), where the fluid is utilized. In this machine, a fitting element (to be described below with reference to FIG. 5) fits threading 22, formed about the opening 24 of the container's neck 26 for regulated withdrawal of fluid from the container. Fitted within the neck is a flow control mechanism 28 (best seen in FIG. 3), for controlling fluid flow.

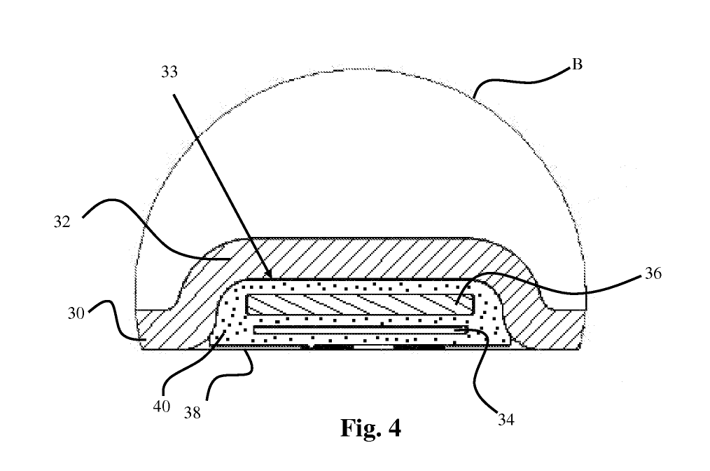

The container has a base 30 with recess 32 accommodating identification module 33. The identification module 33 (shown in detail in FIG. 4), which may also be referred to by some as “smart card”, includes a RFID element 34, shield plate 36, made of a ferromagnetic metal or alloy, and a cover 38. All of these elements are held together and in place, embedded within a matrix 40, which is a solidified adhesive. The identification module may also comprise a layer of polymeric foam (such as foamed polyurethane, not shown), providing additional cushioning and shock absorbing properties. It is noted that RF waves pass through such a polymeric foam layer without interference, therefore data reading from the “smart card” is not hindered.

In an alternative embodiment, the identification module 33 is separately prepared as a matrix, e.g. made from a polymeric material, in which RFID element 34 and shield plate 36 being embedded therein. The module is shaped so as to fit within recess 32 with the outer face thereof being flush with the bottom face of the base 30.

The RFID element known per se includes a RF transceiver and data storage as well as some components for energizing the element, in response to an RF signal from an RF communication module within the machine.

Reference is now made to FIG. 5 showing a machine 50 configured for providing a carbonated drink through a dispensing outlet. The machine, which is shown schematically, includes a receptacle 52 for removably receiving a replaceable container 20 which may be that of the embodiments of FIGS. 1-4, and includes a fitting arrangement 54 for fitting with the neck and through such fitting, permitting gas flow out of the container into tubing 56 within the machine. It should be noted that the flow control arrangement 28 is designed to permit flow only upon engagement of the container's neck with the fitting element.

The machine also includes a RF read/write module 58 which, once the container is in place within the machine, is in juxtaposition to the identification module 33. The machine further includes a processor 60 linked to the RF read/write module 58 and also linked to a controller 70 which controls operation of the machine. In the absence of data identifying that the container is authentic and being filled in an authorized filling facility, the processor will induce the controller to block operation of the machine.

1. A metal container containing a fluid for replaceable incorporation into a machine in which the fluid is utilized, the container having a base, the container comprising:
an identification module at the container's base that comprises an RFID element for storing data relating to the container's identifiers and for communicating such data to an RF communication module in the machine.

2. The container of claim 1, wherein the identification module is positioned within a recess formed at the base.

3. The container of claim 2, wherein said recess is formed at the center of the base.

4. The container of claim 1, wherein the identification module comprises a shielding element between the RFID element and the juxtaposed portion of the base.

5. The container of claim 4, wherein the shielding element is a plate made of a ferromagnetic metal or alloy.

6. The container of claim 1, wherein the data stored in the RFID element includes an identifier for the fluid-filling facility.

7. The container of claim 1, wherein the data stored in the RFID element includes usage data.

8. The container of claim 1, wherein the fluid is pressurized gas.

9. The container of claim 8, wherein the gas is CO₂.

10. The container of claim 8, wherein the gas is utilized for the preparation of a carbonated drink.

11. The container of claim 1, being an aluminum-based container or a steel-based container.

12. A machine comprising a receptacle for removably receiving a fluid-containing container according to claim 1, the container having a base and an opening, the machine comprising a fitting arrangement for fitting with the opening and for drawing fluid therefrom, the receptacle comprising an RF communication module for communication with an RFID element at the container's base to obtain data on the container's identifiers.

13. The machine of claim 12, comprising a processor for receiving and processing said data and controlling operation of the machine based thereon.

14. The machine of claim 12, for preparing a carbonated drink, the fluid being pressurized CO₂.

15. The machine of claim 12, wherein the data comprises data on the fluid-filling facility and said processor being configured to block operation of the machine where said facility is not a recognized one.

16. The machine of claim 12, wherein the data comprises data on usage of said fluid and said processor being configured to block operation of the machine or generate a replacement signal for prompting a user to replace the container when said data indicates that the fluid has been or is close to being exhausted.

17. (canceled)

18. An identification module, comprising an RFID element and a shield plate for fitting into a recess formed in a metal container according to claim 1.

19. The identification of claim 18, formed so an external face thereof is made to be flush with the external face of the container when fitted into said recess.
